(19) United States
(12) Patent Application Publication
(10) Pub. No.: US 2012/0286543 A1
(43) Pub. Date: Nov. 15, 2012

(54) SUBFRAME FOR VEHICLE

(75) Inventor: Sang Ill Lee, Seoul (KR)

(73) Assignee: Hyundai Motor Company, Seoul (KR)

(21) Appl. No.: 13/289,397

(22) Filed: Nov. 4, 2011

(30) Foreign Application Priority Data
May 12, 2011 (KR) 10-2011-0044314

(51) Int. Cl. B62D 25/20

(52) U.S. Cl. 296/204

(57) ABSTRACT

A subframe for a vehicle satisfies durability and crash performance of a rear mounting portion during vehicle crash. The subframe may include an upper reinforcement and a lower reinforcement, which are spaced apart from each other and assembled to the subframe, and a rear mounting bracket connected to a chassis via a mounting bolt, wherein the lower reinforcement includes a bolt pushing-inducing trim line connected to a bolt hole and the upper reinforcement includes a pair of deformation-inducing holes formed on both front and rear of a pipe nut such that the mounting bolt is separated from an initial position and the upper reinforcement is deformed when an impact load is applied.

### CROSS-REFERENCE TO RELATED APPLICATION

This application claims under 35 U.S.C. §119(a) the benefit of Korean Patent Application No. 10-2011-0044314 filed May 12, 2011, the entire contents of which application is incorporated herein for all purposes by this reference.

### BACKGROUND OF INVENTION

1. Field of Invention

The present invention relates to a subframe for a vehicle. More particularly, it relates to a subframe for a vehicle, which satisfies durability and crash performance of a rear mounting portion during vehicle crash.

2. Background Art

In general, a vehicle body comprises suitable combinations of various panels and frames. Especially, a frame structure of the vehicle body has a great influence on the structural stiffness, and thus various types of structures are proposed for the vehicle body to efficiently disperse and absorb the impact applied to the vehicle body during running or during crash.

In a conventional four-wheel drive vehicle, as shown in FIG. 1, a rear vehicle body comprises a subframe 1 to which a damper and the like is connected, a side frame 8 connected to both sides of the subframe 1 via a mounting member and extending in the longitudinal direction of the vehicle body, etc.

The conventional subframe is connected to a chassis via a rear mounting bracket. In order to solve the problem that the rear mounting bracket is being torn during a vehicle crash, a reinforcement is added to an area with minimum stress index in the rear mounting bracket (i.e., the most vulnerable area during analysis of durability performance).

In a conventional rear mounting bracket 2 of a subframe as shown in FIG. 2, an upper reinforcement 3 and a lower reinforcement 4 are provided to be spaced apart from each other and arranged up and down to improve the durability of the rear mounting bracket 2 as shown in FIG. 3. Moreover, a mounting member 6 is provided to assemble a lower pipe 5, which is welded between the upper reinforcement 3 and the lower reinforcement 4, and the rear mounting bracket 2 to a chassis 9.

However, the conventional subframe has the problem that the vehicle's pulse (or the vehicle's pulse severity) occurring due to impact load applied to the vehicle during crash is increased by the reinforcement of the rear mounting bracket provided to improve the durability thereof, which in turn increases the risk of occupant injury, thus reducing the crash performance.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a subframe for a vehicle, which satisfies durability and crash performance of a rear mounting portion in a manner that a lower reinforcement is configured to have a structure capable of changing the position of a mounting bolt assembled to a chassis and an upper reinforcement is configured to have a structure capable of inducing self-deformation during vehicle crash.

In some aspects, the present invention provides a subframe for a vehicle, the subframe comprising an upper reinforcement and a lower reinforcement, which are spaced apart from each other and assembled to the subframe, and a rear mounting bracket connected to a chassis via a mounting bolt, wherein the lower reinforcement comprises a bolt pushing-inducing trim line connected to a bolt hole and the upper reinforcement comprises a pair of deformation-inducing holes formed on both front and rear of a pipe nut such that the mounting bolt is separated from an initial position and the upper reinforcement is deformed when an impact load is applied.

In various aspects of the present invention, the bolt pushing-inducing trim line is configured to extend to the most adjacent edge of the lower reinforcement to open one side of the lower reinforcement.

In other aspects of the present invention, the deformation-inducing holes comprise a first hole formed with a width similar or corresponding to that of the pipe nut in the left and right direction and a second hole formed on the opposite side of the first hole with a width similar or corresponding to that of the body of the mounting bolt in the left and right direction.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram showing a rear mounting portion of a conventional subframe for a vehicle.

FIG. 2 is a cross-sectional view taken along line A-A of FIG. 1.

FIG. 3 is a perspective view showing an upper reinforcement and a lower reinforcement of FIG. 2.

FIG. 4 is an exploded perspective view showing the configuration of an exemplary rear mounting portion of a subframe for a vehicle in accordance with the present invention.

FIG. 5 is an assembled perspective view showing the configuration of an exemplary rear mounting portion of a subframe for a vehicle in accordance with the present invention.

FIG. 6 is a cross-sectional view taken along line B-B of FIG. 5.

FIG. 7 is a perspective view showing an exemplary upper reinforcement and lower reinforcement in accordance with the present invention.

FIG. 8 is a diagram showing the results of analysis of an exemplary vehicle's pulse severity in accordance with the Test Example of the present invention.

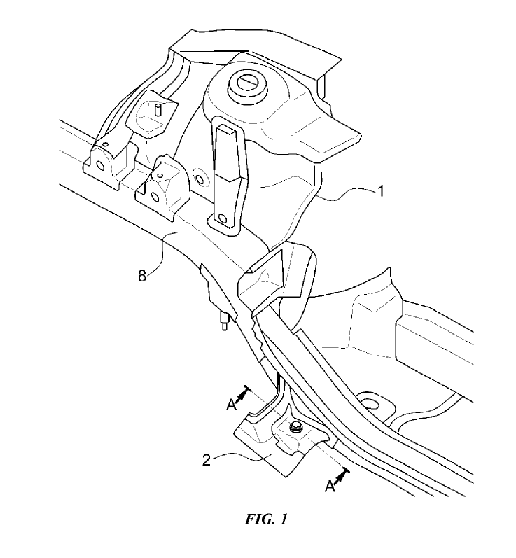

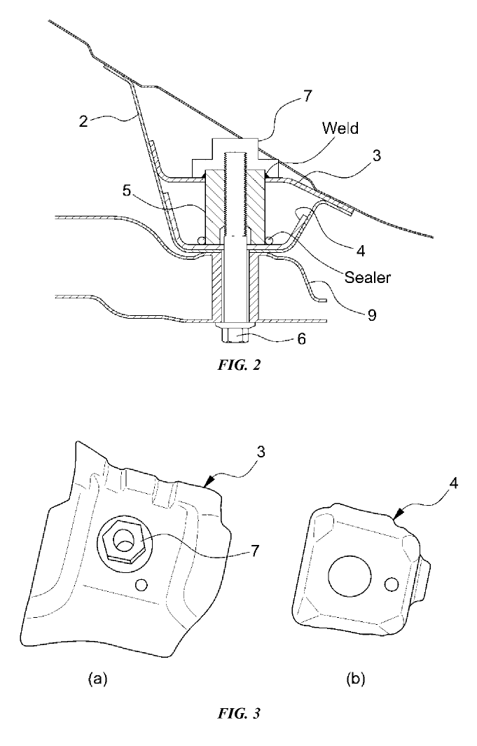

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Various embodiments of the present invention provide a subframe provided at the bottom of a vehicle, which can satisfy durability and crash performance by modifying a rear mounting portion, i.e., a rear mounting bracket, of the subframe to which reinforcements are added and which has conventionally caused deterioration of crash performance.

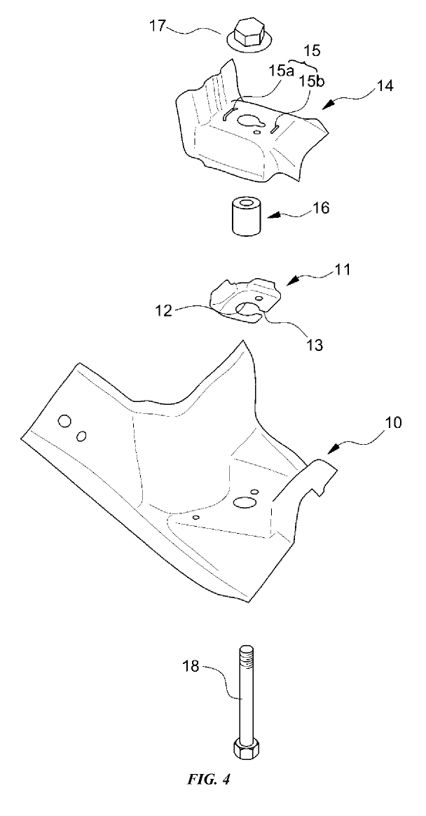

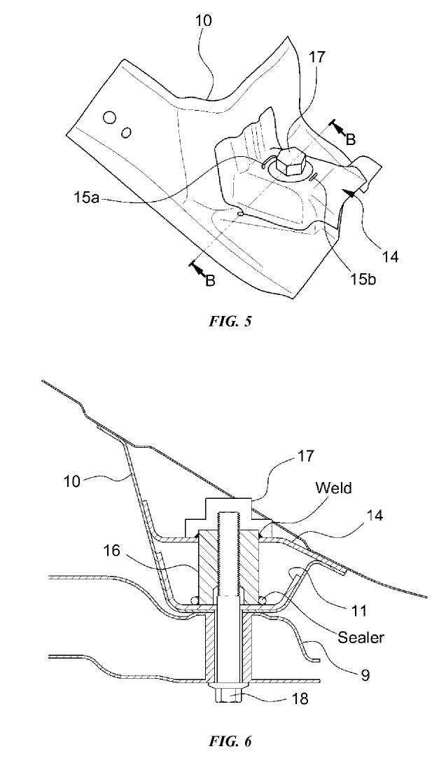

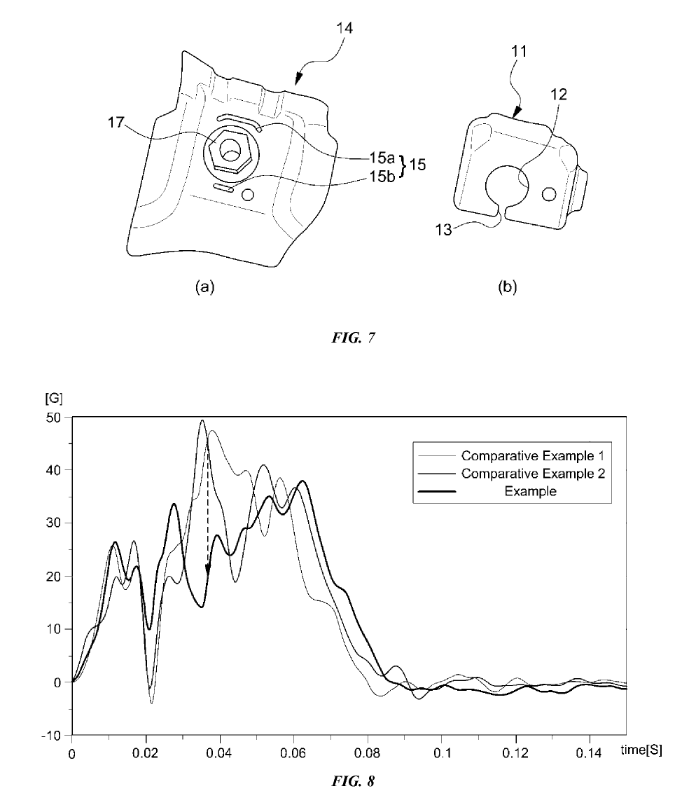

As shown in FIG. 4, a subframe in accordance with various embodiments of the present invention is connected to a chassis 9 of a vehicle via a rear mounting bracket 10 provided at one side thereof, and reinforcements 11 and 14 as shown in detail in FIG. 7 are provided in the rear mounting bracket 10 to improve durability.

As shown in FIG. 6, the reinforcements 11 and 14 comprise a lower reinforcement 11 attached closely to the rear mounting bracket 10 and an upper reinforcement 14 spaced a predetermined distance from the lower reinforcement 11 and assembled to the rear mounting bracket 10.

That is, the upper reinforcement 14 and the lower reinforcement 11 are arranged up and down in a predetermined region of the rear mounting bracket 10.

A lower pipe 16 penetrating the upper reinforcement 14 is placed on the lower reinforcement 11 and welded to the upper reinforcement 14. The lower reinforcement 11 and the lower pipe 16 are connected to each other via a noise-proof sealer, for example.

Moreover, a pipe nut 17 is welded to the top of the upper reinforcement 14 and connected to a mounting bolt 18, which penetrates the chassis 9, the rear mounting bracket 10, the reinforcements 11 and 14, and the lower pipe 16, such that the rear mounting bracket 10 is assembled to the chassis 9.

That is, the rear mounting bracket 10 to which the reinforcements 11 and 14 are assembled is connected to the chassis 9 via the mounting bolt 18 and the pipe nut 17.

Meanwhile, as shown in FIG. 7, the lower reinforcement 11 comprises a bolt pushing-inducing trim line 13 connected to a bolt hole 12 through which the mounting bolt 18 penetrates.

The bolt pushing-inducing trim line (hereinafter, referred to as a trim line) 13 is configured to have a structure capable of absorbing impact in such a manner that the mounting bolt 18 is pushed and moved by an impact load during vehicle crash. The trim line 13 may extend from the bolt hole 12 to the edge of the lower reinforcement 11.

Preferably, the trim line 13 starts from one side of the bolt hole 12 and extends to the other side on the edge of the lower reinforcement 11, thereby opening one side of the lower reinforcement 11.

Therefore, the mounting bolt 18 is moved from the initial position along the trim line 13 when the impact load is applied, thus absorbing impact energy. Moreover, the mounting bolt 18 may be separated from the lower reinforcement 11 or from the rear mounting bracket 10 depending on the magnitude of the impact energy.

That is, when the mounting bolt 18 is pushed and moved along the trim line 13, it can be moved and separated from the initial position depending on the magnitude of the impact energy, thereby enhancing the effect of impact absorption.

Moreover, the trim line 13 has a width smaller than that of the mounting bolt 18 such that the mounting bolt 18 pushes the lower reinforcement 11 on both sides of the trim line 13 from side to side when it is moved.

In other words, the trim line 13 can absorb the impact energy in a manner that the mounting bolt 18 receiving the impact load is moved and/or separated from the initial position along the trim line 13, not in a manner that the mounting bolt 18 receiving the impact load is certainly separated from the lower reinforcement 11 or from the rear mounting bracket 10.

That is, the trim line 13 can absorb the impact energy during crash by the position change of the mounting bolt 18 itself, even when the mounting bolt 18 is not completely separated from the lower reinforcement 11 or from the rear mounting bracket 10.

Moreover, the upper reinforcement 14 comprises a pair of bracket deformation-inducing holes 15 having a slit shape and formed on both front and rear of the pipe nut 17 to induce deformation of the upper reinforcement 14 when an impact load is applied thereto.

The bracket deformation-inducing holes (hereinafter, referred to as deformation-inducing holes) 15 allow the upper reinforcement 14 itself to be torn or deformed such that the rear mounting bracket 10 is deformed, thus absorbing the impact energy. Accordingly, the deformation-inducing holes 15 are formed in optimal positions.

For example, the deformation-inducing holes 15 may comprise a first hole 15a formed with a width similar or corresponding to that of the pipe nut 17 in the left and right direction and a second hole 15b formed on the opposite side of the first hole 15a with a width similar or corresponding to that of the body of the mounting bolt 18 in the left and right direction.

Therefore, the upper reinforcement 14 can be easily crushed or torn more than the absence of the deformation-inducing holes 15 during crash, thereby efficiently absorbing the impact energy.

As such, with the improved structure of the rear mounting portion of the subframe according to the present invention, it is possible to allow the upper reinforcement to be deformed and the mounting bolt to be pushed backward against the impact load, thereby absorbing the impact energy.

That is, the vehicle's pulse (or the vehicle's pulse severity) occurring due to an impact load applied to the vehicle during crash is reduced, which in turn reduces the risk of occupant injury, thus improving the crash performance. As a result, the subframe of the present invention can satisfy durability and crash performance to meet the NCAP ratings.

Next, the effects of the present invention will be described in detail through the results of analysis of the durability of the subframe and the vehicle's pulse.

### EXAMPLE

As starting components to be assembled to a rear mounting bracket of a subframe, an upper reinforcement and a lower reinforcement with a structure shown in FIG. 7 and Table 1 were manufactured.

### Comparative Example 1

As starting components to be assembled to a rear mounting bracket of a subframe, an upper reinforcement and a lower reinforcement with a structure shown in FIG. 3 and Table 1 were manufactured.

### Comparative Example 2

As starting components to be assembled to a rear mounting bracket of a subframe, an upper reinforcement and a lower reinforcement with a structure shown in Table 1 were manufactured.

### Test Example

After each of the reinforcements in the Example and Comparative Example 1 and 2 was mounted on a rear mounting portion of a front subframe for a vehicle under the same conditions, a crash test was performed on each vehicle under the same conditions, and the durability and crash performance were evaluated.

Braking and cornering under a load of 1 G using a virtual test laboratory (VTL) was applied to each rear mounting portion of the subframe employing the reinforcements in the Example and Comparative Example 1 and 2 to evaluate the stress index. Moreover, the durability index of each rear mounting portion was evaluated by BIG durability analysis and X C durability analysis, and the results are shown in FIG. 8 and Tables 1 and 2.

FIG. 8 is a diagram showing the results of the vehicle's pulse severity due to an impact load applied to each vehicle.

TABLE 2

| | Comparative | | Comparative | | | |
|---|---|---|---|---|---|---|
| Vehicle | Example 1 | | Example 2 | | Exampe | |
| Pulse severity | 67% | | 61% | | 49% | |
| (Target: 55%) | | | | | | |
| Maximum | 47.4 | g | 49.4 | g | 37.9 | g |
| Deceleration | | | | | | |
| Dynamic | 594 | mm | 618 | mm | 635 | mm |
| Displacement | | | | | | |
| Vehicle Dipping (?) | 96 | mm | 90 | mm | 43 | mm |

| | | | |
|---|---|---|---|
| Durability Index | Satisfied | Satisfied | Satisfied |
| Occupant Injury | Unsatisfied | Unsatisfied | Satisfied |

TABLE 3

| Classification | General Rating | Front Rating | Pulse Severity |
|---|---|---|---|
| Target | 5.1★ | 4.8★ | 55% |
| Comparative | 4.9★ | 4.0★ | 67% |
| Example 1 | | | |
| Example | 5.1★ | 4.8★ | 49% |

As shown in Table 1, it can be seen from the results of the Test Example that all of the Example and Comparative Examples 1 and 2 satisfied the stress index of more than LO and the durability index of more than 1.0.

As shown in Table 2, while the Example satisfied the vehicle's pulse severity at a target value of less than 55%, Comparative Examples 1 and 2 did not satisfy the target value of the vehicle's pulse severity, from which it can be seen that only the Example according to the present invention satisfied the requirements for occupant injury.

Especially, as can be seen from the graph of FIG. 8 showing the results of the analysis of the vehicle's pulse severity, while Comparative Examples 1 and 2 showed the maximum value of the vehicle's pulse near the time of 0.035 seconds, the Example significantly reduced the vehicle's pulse near the time of 0.035 seconds.

Moreover, in the case of Comparative Examples 1 and 2, the mounting bolt was not separated from the subframe, however, in the case of the Example, the mounting bolt was pushed on the subframe by the impact load, and thus its position was moved.

It can be seen from the analysis of the durability and the vehicle's pulse severity that the dynamic displacement of the vehicle was increased by the structure according to the present invention applied to the rear mounting portion of the subframe during vehicle crash, and thus the vehicle's pulse severity was reduced.

As the pulse severity was significantly reduced, the risk of occupant injury during crash was reduced, and thus the front crash rating in the US NCAP crash tests was increased and the target of the general rating was achieved.

As such, according to the present invention, the mounting bolt was moved from the initial position together with the deformation of the upper reinforcement, which reduced the risk of occupant injury, thus achieving the NCAP vehicle safety rating, compared to the case where the mounting bolt was completely separated from the subframe.

As described above, the subframe for a vehicle according to the present invention can reduce the vehicle's pulse severity occurring due to an impact load, which in turn reduces the risk of occupant injury, thus satisfying the durability and crash performance, by modifying the rear mounting portion of the subframe to which the reinforcements are added and which has conventionally caused deterioration of crash performance.

For convenience in explanation and accurate definition in the appended claims, the terms upper or lower, front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A subframe for a vehicle, the subframe comprising an upper reinforcement and a lower reinforcement, which are spaced apart from each other and assembled to the subframe, and a rear mounting bracket connected to a chassis via a mounting bolt, wherein the lower reinforcement comprises a trim line connected to a bolt hole and the upper reinforcement comprises a pair of deformation-inducing holes formed on both front and rear of a pipe nut such that the mounting bolt is separated from an initial position and the upper reinforcement is deformed upon impact.

2. The subframe of claim 1, wherein the trim line is configured to extend to the most adjacent edge of the lower reinforcement to open one side of the lower reinforcement.

3. The subframe of claim 1, wherein the deformation-inducing holes comprise a first hole formed with a width similar or corresponding to that of the pipe nut in the left and right direction and a second hole formed on the opposite side of the first hole with a width similar or corresponding to that of the body of the mounting bolt in the left and right direction.
